(19) United States
(12) Patent Application Publication
(10) Pub. No.: US 2011/0047860 A1
(43) Pub. Date: Mar. 3, 2011

(54) BED BUG CAPTURING DEVICE

(75) Inventors: Bruce C. Black, Yardley, PA (US); Shreya J. Shah, Lawrenceville, NJ (US); Linda A. Varanyak, Mercerville, NJ (US); Keith F. Woodruff, Mountainside, NJ (US)

(73) Assignee: FMC CORPORATION, Philadelphia, PA (US)

(21) Appl. No.: 12/872,310

(22) Filed: Aug. 31, 2010

Related U.S. Application Data
(60) Provisional application No. 61/275,825, filed on Sep. 3, 2009.
(60) Provisional application No. 61/286,909, filed on Dec. 16, 2009.

(51) Int. Cl. A01M 1/10

(52) U.S. Cl. 43/123; 43/121; 43/107

(57) ABSTRACT

The present invention relates to a bed bug capturing device comprising: (a) a bed bug attractant element; and (b) a deadfall capturing element comprising at least one pathway comprising: (i) an upwardly sloped segment; (ii) a downwardly sloped segment having an outer portion; and (iii) a deadfall trap area: characterized in that the upwardly sloped segment and at least the outer portion of the downwardly sloped segment possesses an average surface roughness of at least about 2.5 micrometers.

### FIELD OF THE INVENTION

The present invention relates to a bed bug capturing device.

### BACKGROUND OF THE INVENTION

Bed bugs are small nocturnal insects of the family Cimicidae that feed off the blood of humans and other warm blooded hosts. Bed bugs exhibit cryptic behavior, which makes their detection and control difficult and time consuming. This is particularly true for the common bed bug, Cimex lectularius, which has become well adapted to human environments. Other species of bed bugs are nuisances to people and/or animals as well.

While bed bugs have been controlled in many areas, such as the United States, the increase in international travel has contributed to a resurgence of these pests in recent years. There are many aspects of bed bugs which make it difficult to eradicate them once they have established a presence in a location. Accordingly, there is a need for effective traps to determine the presence of bed bugs before they become entrenched.

Adult bed bugs are about 6 millimeters long, 5 to 6 millimeters wide, and are reddish brown with oval, flattened bodies. The immature nymphs are similar in appearance to the adults, but are smaller and lighter in color. Bed bugs do not fly, but can move quickly over surfaces. Female bed bugs lay their eggs in secluded areas and can deposit up to five eggs per day, and as many as 500 during a lifetime. The bed bug eggs are very small, about the size of a dust spec. When first laid, the eggs are sticky causing them to adhere to surfaces.

Bed bugs can go for long periods of time without feeding. Nymphs can survive for weeks without feeding, while adults can survive for months. Consequently, infestations cannot be eliminated simply by leaving a location unoccupied for brief periods of time. Further, such feeding habits make it difficult to monitor whether bed bugs are present as they may only be attracted to bait when hungry. Thus, in order to be effective, a bed bug capturing device must be able to generate attractants at an effective concentration for an extended period of time.

While bed bugs are active during the nighttime, during daylight they tend to hide in tiny crevices or cracks. Bed bugs may therefore find easy hiding places in beds, bed frames, furniture, along baseboards, in carpeting and countless other places. Bed bugs tend to congregate but do not build nests like some other insects.

Bed bugs obtain their sustenance by drawing blood through elongated mouth parts. They may feed on a human for 3 to 10 minutes, although the person is not likely to feel the bite. After the bite, the victim often experiences an itchy welt or a delayed hypersensitivity reaction resulting in a swelling in the area of the bite. However, some people do not have any reaction or only a very small reaction to a bed bug bite. Bed bug bites have symptoms that are similar to other pests, such as mosquitoes and ticks. It is not possible to determine whether a bite is from a bed bug or another type of pest; and bites may be misdiagnosed as hives or a skin rash. Consequently, bed bug infestations may frequently go on for long periods before they are recognized.

Bed bug infestations originate by a bed bug being carried into a new area. Bed bugs are able to cling to possessions and hide in small spaces, such that they may be transported in a traveler's belongings. As a result, buildings where the turnover of occupants is high, such as hotels, motels, inns, barracks, cruise ships, shelters, nursing homes, camp dwellings, dormitories, condominiums and apartments, are especially vulnerable to bed bug infestations.

Because of all the features of bed bugs described herein, bed bugs are both difficult to detect and eradicate. Professional pest removal specialists and pesticides are needed. It is necessary to remove all clutter and unnecessary objects from a room, remove bed bugs and eggs as much as possible through vacuuming, and apply pesticides to likely hiding areas. This type of treatment for eradication can be disruptive to a business such as a hotel. As a result, it is desirable to detect bed bugs at the earliest possible moment before an infestation becomes established.

The tiny, mobile and secretive behavior of bed bugs makes it nearly impossible to prevent and control an infestation unless they are quickly discovered and treated. Bed bugs have been found to move through holes in walls, ceilings and floors into adjacent rooms. Devices and methods for the early detection of bed bugs are especially needed in the hospitality industries.

While several attempts have been made to devise bed bug capturing devices in the past, these devices have, in general, not proven to be commercially effective. The present inventors have studied many aspects of bed bug behavior, and believe that one factor in the failure of such devices to desirably perform is the lack of an effective trapping mechanism.

Thus, it has been observed by the present inventors that bed bugs, unlike many other insect pests, are resistant to many types of sticky traps, having the ability to cross traps that would snare other insects, particularly where a heating element is not employed. Consequently, bed bug monitors that rely upon luring bed bugs to sticky traps may not be effective as the bed bugs may simply walk across the trap surface and eventually exit the device.

Further, bed bugs are extremely sensitive to the roughness of the surfaces on which they are placed. Bed bugs tend to avoid crossing smooth surfaces, rendering current traps which require such a traversal before they are trapped ineffective. Indeed, it has been unexpectedly found that traps having a textured surface which are effective to control other insect species are (when modified to contain a bed bug attractant) ineffective to control bed bugs as their surface is apparently too smooth for the bed bugs despite such outwardly rough appearance.

The present invention overcomes the above-identified problems by providing novel bed bug capturing devices.

### SUMMARY OF THE INVENTION

The present invention relates to a bed bug capturing device comprising: (a) a bed bug attractant element; and (b) a deadfall capturing element comprising at least one pathway comprising: (i) an upwardly sloped segment; (ii) a downwardly sloped segment having an outer portion; and (iii) a deadfall trap area; characterized in that the upwardly sloped segment and at least the outer portion of the downwardly sloped segment possesses an surface roughness of at least about 2.5 micrometers.

### DESCRIPTION OF THE DRAWINGS

FIG. 1 is a side view of a first embodiment of the deadfall capturing element pathway employed in the capturing device of this invention.

FIG. 2 is a side view of a second embodiment of the deadfall capturing element pathway employed in the capturing device of this invention.

FIG. 3 is a side view of a third embodiment of the deadfall capturing element pathway employed in the capturing device of this invention.

FIG. 3A is an enlarged view of the inward portion of the upwardly sloped segment and the downwardly sloped segment the embodiment shown in FIG. 3.

FIG. 4 is a side view of one embodiment of the device of this invention which is circular in construction.

FIG. 5A is a perspective view of a bed bug capturing device according to an aspect of the invention.

FIG. 5B is a perspective view of a portion of a bed bug capturing device according to an aspect of the invention.

FIG. 6 is a longitudinal cross-section of a bed bug capturing device according to an aspect of the invention.

FIG. 7 is a cross-section of a bed bug capturing device according to an aspect of the invention.

FIG. 8 is a top view of a bed bug capturing device according to an aspect of the invention.

### DETAILED DESCRIPTION OF THE INVENTION

In one aspect, the present invention relates to a bed bug capturing device comprising: (a) a bed bug attractant element; and (b) a deadfall capturing element comprising at least one pathway comprising: (i) an upwardly sloped segment; (ii) a downwardly sloped segment having an outer portion; and (iii) a deadfall trap area; characterized in that the upwardly sloped segment and at least the outer portion of the downwardly sloped segment possesses an average surface roughness of at least about 2.5 micrometers.

The capturing device of this invention may be used as a monitoring device in order to determine whether bed bugs are present; and/or as a device for controlling bed bugs.

The device of this invention may comprise any bed bug attractant which is effective to lure the bed bugs into the device such that they enter into the pathway of the deadfall element and follow the path until they become trapped in the trap area. Attractants which may be employed include carbon dioxide, heat, pheromones, human sweat components and the like, all of which are known to those of skill in the art. Mixtures of one or more attractants may also be employed.

Preferably, the attractant employed comprises at least one member of the group consisting of organic acids and aldehydes; and more preferably comprises at least one member of the group consisting of butyric acid, trans-2-hexen-1-al (Hexenal) and trans-2-octen-1-al (Octenal).

One particularly preferred attractant comprises an unsaturated aldehyde component and an organic acid component. It is preferred that the unsaturated aldehyde component be comprised of one or more aldehydes selected from the group consisting of Hexenal and Octenal. It is preferred that the organic acid component be butyric acid. When the aldehyde component is comprised of both Hexenal and Octenal, it is preferred that the aldehydes be present in a ratio of from about 1:5 and about 5:1 of Hexenal to Octenal, more preferably in a ratio of between about 3:1 and about 1:3. In order to be most attractive to bed bugs, the optimal concentration of the Hexenal and Octenal mixture to be released is from about 50 ng/L/hr to about 200 ng/L/hour, and the optimal concentration of butyric acid to be released is between about 15 ng/L/hr and about 50 ng/L/hr. Mixing butyric acid with Hexenal and Octenal forms an unstable composition and it is necessary to separate the aldehyde component from the acid component. In order for the separate components of the attractant composition to be released at the proper rates, each component may be dissolved in an organic solvent, for example a C₈-C₁₂ alkane. For applications in which the device may be subjected to temperature fluctuations between about 20° C. and 40° C., decane and undecane are particularly preferred solvents as their rate of volatilization is less affected by such temperature fluctuations than is nonane.

In one aspect of the invention suitable attractants comprise Octenal dissolved in decane at a concentration range of about 2000 to 3000 ppm Octenal, preferably from about 2500 to 2800 ppm octenal, and more preferably from about 2700 to 2750 ppm Octenal. A second suitable attractant that can be used in conjunction with the Octenal is butyric acid dissolved in decane at a concentration range of about 200 to 2000 ppm butyric acid, and preferably from about 240 to 400 ppm butyric acid.

Each component may be incorporated into an absorbent material, for example, but not limited to cotton batting, fiberized cellulose wood pulp, synthetic batting, polyester batting, felt, bonded carded webs, very high density polyethylene sponge and high loft spunbond materials. In order to regulate diffusion, a semi-permeable membrane can be used to encase the absorbent materials. The attractant components can be dispensed from containers with either a semi-permeable top or a sealed top containing one or more holes to allow diffusion into the surrounding atmosphere.

In one particularly preferred embodiment, the attractant is contained in an ampoule comprising: an outer shell composed of an impermeable material and defining at least one opening; a porous diffusion member defining an internal reservoir positioned inside said outer shell; a volatile liquid comprising the attractant contained within such internal reservoir; and a film member adhered to said outer shell and covering said at least one opening; wherein said film member is disposed such that an air space is present between said porous diffusion member and said film member; and wherein said porous diffusion member is configured such that molecules of the volatile liquid can only enter into said air space via diffusion through said porous diffusion member. The film member may be composed of a permeable material though which the attractant will diffuse at a desired rate; or it may be made of an impermeable material and define one or more holes of a predetermined size in order to release the attractant at a desired rate.

The device should be configured such that the bed bugs are lured into the pathway of the deadfall element and induced to follow it until they are trapped in the trap area. This may be accomplished by locating the attractant within the walls of the deadfall trap area, e.g., by having the attractant pass through one or more chimneys or holes located within the radius of the trap area.

The attractant element of this invention may comprise one or more means of providing air flow such that the attractant is dispersed in quantities which will attract bed bugs. Any means which will produce the desired air flow may be employed including heat, compressed gas (particularly when carbon dioxide is employed as the attractant), air pumps, fans, and the like. When the attractant comprises a chemical attractant which is heavier than air which is not under compression, such as pheromones, organic acids or other attractants (including the mixed aldehyde/organic acid mixture described above), the preferred air movement means is a fan, such that such device has a face velocity of between about 5 and about 50 ml/cm²/min, more preferably of between about 10 and about 40 ml/cm²/min., and most preferably of between about 15 and about 35 ml/cm²/min.

The trap pathway area may comprise one or more channels located within the device. Alternatively, the pathway may comprise at least a portion of the outer shell of the device. In a further aspect, the pathway may encompass the entire base or outer shell of the device, for example, forming a frusto-conical structure. In other embodiments, a combination of ramps and channels may be employed. Alternatively, if a vertically positioned trap is desired, the trap pathway may comprise a 180 degree ramp (when viewed from the top) or a portion thereof.

The trap pathway is comprised of three portions: an upwardly sloped segment; a downwardly sloped segment; and a trap area.

The upwardly sloped segment may, when viewed in cross-section, be planar, concave or convex; alternatively such segment may comprise two or more subsegments, e.g., a convex portion and a planar portion; or such segment may comprise a series of small steps so long as they form a surface of sufficient roughness in the aggregate. In one preferred embodiment, such segment comprises at least two planar portions which are set at different vertical slopes.

The upwardly sloped segment may be of any slope which will permit bed bugs to climb along its surface. Preferably, such segment will have an overall incline of between about 20 and about 75 degrees; more preferably of between about 30 and about 45 degrees.

The downwardly sloped segment may, when viewed in cross-section, be planar, concave, convex or a mixture of the foregoing. However, concave surfaces are generally not preferred, as they may interfere with the bed bugs falling into the trap portion of the device.

The downwardly sloped segment may further comprise a horizontal subsegment which extends along its outer perimeter and connects to or is integral with the upwardly sloped segment.

In those embodiments in which the downwardly sloped segment comprises a convex surface (e.g., where such portion is a curve in cross-section) the radius of the curve is preferably between about one-sixteenth and about one-half inch.

The trap area of the trap pathway comprises a substantially vertical portion and a substantially horizontal portion. As is employed herein, the term “substantially vertical” refers to a slope which is steep enough to deter bed bugs from climbing out of the trap area. The substantially vertical portion preferably possesses a smooth, low-friction finish which will further deter the bed bugs from escaping. Such a dead fall should have an average surface roughness of about 2.3 micrometers or less. The depth of the deadfall created by the vertical portion is preferably at least about 1 cm, and is more preferably at least about 2 cm. deep.

If desired, the trap area may contain an insecticide or a viscous liquid which will further immobilize or kill bed bugs. The trap area may also comprise a sticky surface, particularly if a heating element is present; however, the presence of such a sticky trap area is not required.

The pathway of the deadfall employed in the device of this invention is characterized in that the upwardly sloped segment and at least the outer portion of the downwardly sloped segment possesses an average surface roughness of at least about 2.5 micrometers, more preferably of at least about 3.0 micrometers. Average surface roughness is the arithmetic average height of roughness irregularities measured from a mean line within an evaluation length. The average surface roughness of a material can be measured using a Pocket Surf® portable surface roughness gage available from Mahr Federal Inc.

As is demonstrated in the Examples below, bed bugs are very sensitive to the roughness of the surfaces which they cross. In general, bed bugs will avoid crossing smooth surfaces having an average surface roughness of less than about 2.3 micrometers. Consequently, devices which employ traps having surfaces which do not possess a sufficient degree of roughness may be ineffective as bed bugs may refuse to follow such pathways until they have reached a point of no return.

In contrast, the upwardly sloped segment and at least the outer portion of the downwardly sloped segment of the devices of the present invention possess a sufficient degree of surface roughness such that bed bugs will be drawn along the pathway until a point where it becomes difficult for them to escape. In preferred embodiments, the bed bugs will be lured onto a downward slope before encountering a smooth surface which will facilitate them falling into the trap area of the deadfall. As will be recognized by one of skill in the art, the optimum extent of the high-roughness area of the downwardly sloping segment will depend upon the particular configuration employed. The smooth surface should possess an average surface roughness of less than about 2.3 micrometers.

The deadfall capturing element may be made of any suitable material or materials which do not repel bed bugs. Preferred materials include hard plastics such as high impact polyethylene or acrylonitrile butadiene styrene. Other materials which may be employed include polychlorotrifluoroethylene, polyvinylidene chloride, high density polyethylene, polypropylene, cardboard, wax paper board, galvanized metal and aluminum.

If the surfaces of the materials used to construct the upwardly sloped segment and the outer portion of the downwardly sloped segment do not possess sufficient surface roughness, their surfaces can be modified by treating their surface with an abrasive material (such as sandpaper or a wire brush) or by adhering an appropriate material to the appropriate pathway surfaces (e.g, by gluing a cloth or paper to smooth plastic or metal). In one preferred embodiment at least a portion of such segments are molded from a plastic (such as polyethylene or polypropylene) which contains a filler material (such as glass, glass particles, glass fibers or talc) which will provide an adequate surface roughness. Although any amount of filler which will provide a suitable average surface roughness may be employed, preferred filler content when glass particles are employed as the roughening filler will typically range from about 10% to about 30% by weight of the final glass/polymer composition, with about 20% by weight glass particle content being particularly preferred.

It is preferred that the device be dark in color, for example black, dark gray, navy blue, dark blue or deep violet as bed bugs tend to choose darker surfaces over lighter surfaces. In general, colors darker than a photographic gray card are preferred.

When employing the bed bug capturing device of this invention, care should be taken to ensure that the device is placed flush with the surface on which it is positioned in order to avoid having the bed bugs crawl underneath instead of into the trap.

The present invention may be better understood by reference to the attached Figures which are intended to be demonstrative of certain embodiments, but are not intended to be limiting of the scope of the invention in any manner.

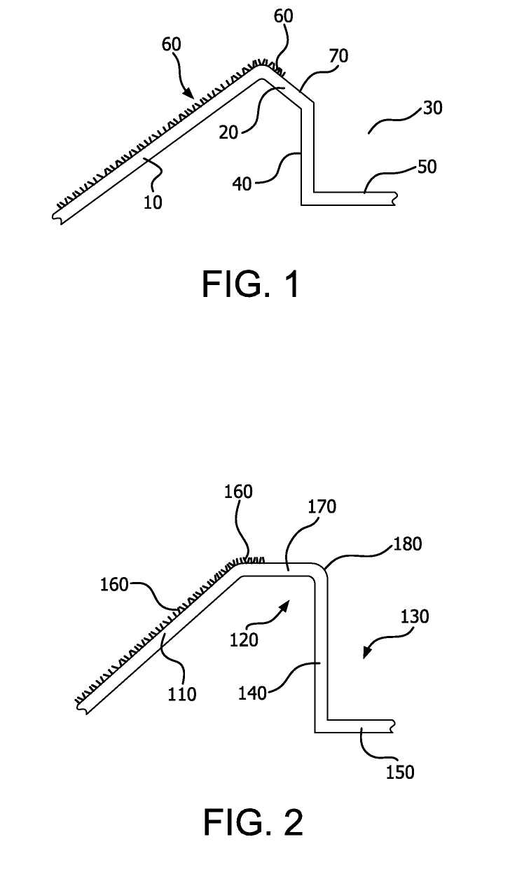

FIG. 1 is a side view of a first embodiment of the deadfall capturing element pathway employed in the bed bug capturing device of this invention. In this embodiment, such pathway is comprised of upwardly sloped segment 10, downwardly sloped section 20 and deadfall trap area 30, which is defined by substantially vertical portion 40 and substantially horizontal portion 50. It is noted that, in this embodiment, both upwardly sloped segment 10 and downwardly sloped segment 20 are planar. The outer surface of upwardly sloped segment 10 and the outer portion of downwardly sloped portion 20 are roughened (in those areas marked as 60) such that they possess an average surface roughness of at least about 2.5 micrometers. The inner portion 70 of downwardly sloped segment 20 has a smooth, slippery surface having an average surface roughness of less than about 2.3 micrometers, as does substantially vertical section 40. Bed bugs are drawn by the attractant (not shown) up the rough surface 60 of upwardly sloped segment 10 and down rough surface 60 of downwardly sloped segment 20. At this point they encounter the slippery inner portion 70 of downwardly sloped segment 20 and fall into deadfall trap area 30 where they are trapped.

FIG. 2 is a side view of a second embodiment of the deadfall capturing element pathway employed in the monitoring device of this invention. In this embodiment, such pathway is comprised of upwardly sloped segment 110, downwardly sloped section 120 and deadfall trap area 130, which is defined by substantially vertical portion 140 and substantially horizontal portion 150. Downwardly sloped section 120 is comprised of horizontal subsegment 170 and curved subsegment 180. The outer surface of upwardly sloped segment 110 and the outer section of downwardly sloped portion 120 are roughened (in those areas marked as 160) such that they possess an average surface roughness of at least equal about 2.5 micrometers. The inner portion of downwardly sloped segment 120 has a smooth slippery surface having an average surface roughness of less than about 2.3 micrometers. It is to be noted that curved subsegment 180 preferably has a curve radius of between about one-sixteenth and about one-half inch. A sharper angle is not preferred as bed bugs tend to avoid vertical drops.

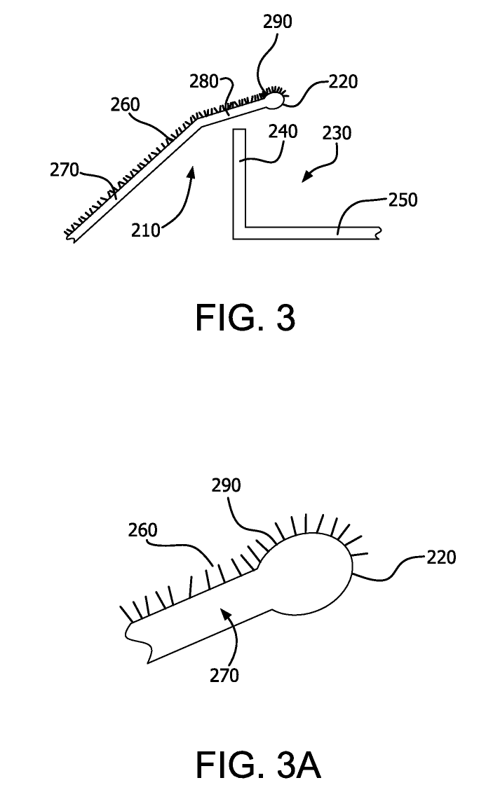

FIG. 3 is a side view of a third embodiment of the deadfall capturing element pathway employed in the monitoring device of this invention; while FIG. 3A is an enlarged view of the inward portion of the upwardly sloped segment and the downwardly sloped segment of this embodiment. In this embodiment, such pathway is comprised of upwardly sloped segment 210, downwardly sloped section 220 and deadfall trap area 230, which is defined by substantially vertical portion 240 and substantially horizontal portion 250. Upwardly sloped segment 210 is comprised of a first planar slope 270 and a second planar slope 280, which are at different inclines, and upwardly curved section 290. Upwardly curved section 290 merges into downwardly sloped segment 220 so as to form a continuously curved surface. The outer surface of upwardly sloped segment 210 and the outer section of downwardly sloped portion 220 are roughened (in those areas marked as 260) such that they possess an average surface roughness of at least equal about 2.5 micrometers.

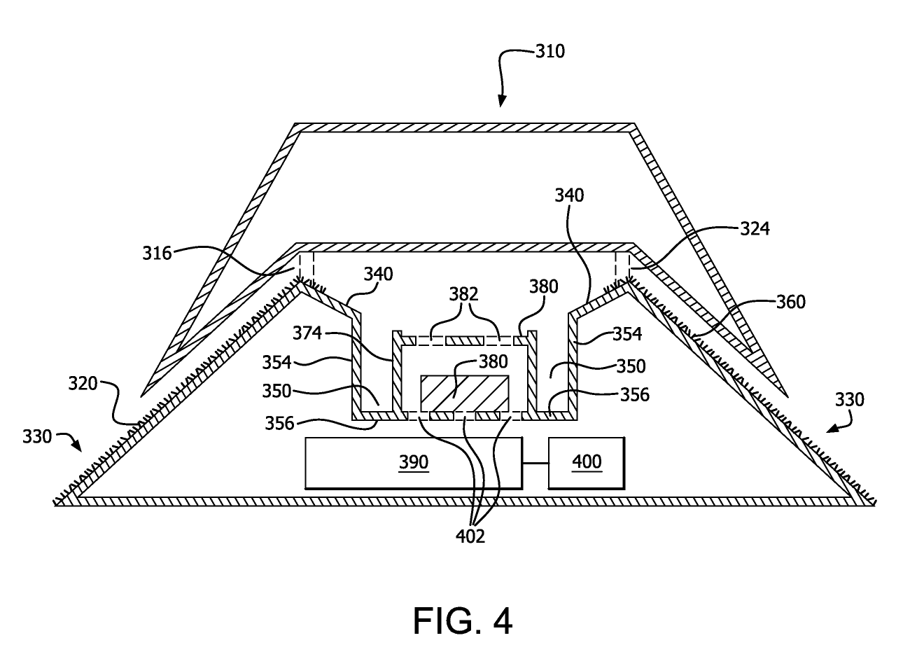

FIG. 4 is a side view of one embodiment of the device of this invention which is circular in construction. This device is composed of top member 310 and bottom member 320, which are connected by rods 324 and 326. Bottom member 320 comprises a deadfall capturing element comprised of upwardly sloped segment 330, downwardly sloped segment 340, and deadfall trap area 350 which is defined by substantially vertical wall 354 and substantially horizontal base 356. The outer surface of upwardly sloped segment 330 and the outer section of downwardly sloped portion 340 are roughened (in those areas marked as 360) such that they possess an average surface roughness of at least equal about 2.5 micrometers.

The device further comprises a bed bug attractant element comprised of attractant 380 which is placed inside a well located in the trap area formed by wall 374. Foil layer 370, containing holes 382, is stretched across and bonded to wall 374. The attractant element further comprises fan 390, which is powered by battery 400, although alternatively an external power source could be employed. Although placed on the bottom of the unit in this particular embodiment, it is understood that the configuration of the devise could readily be modified by one of ordinary skill in the art to place the fan elsewhere, e.g., in the cover or on the side of the attractant. Air created by the circulation of fan 390 passes through holes 402, causing molecules of attractant 380 to pass through holes 382 and eventually out of the device. By regulating the fan speed and hole size, the rate of attractant dispersion can be regulated as desired.

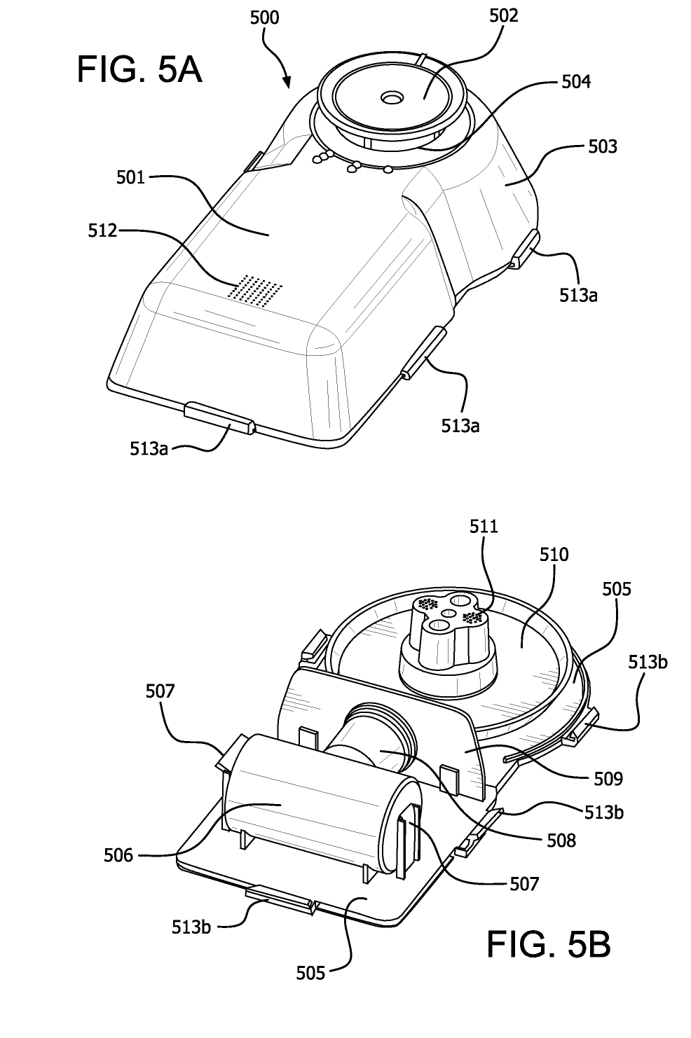

A further embodiment will be described with reference to FIGS. 5A through 8.

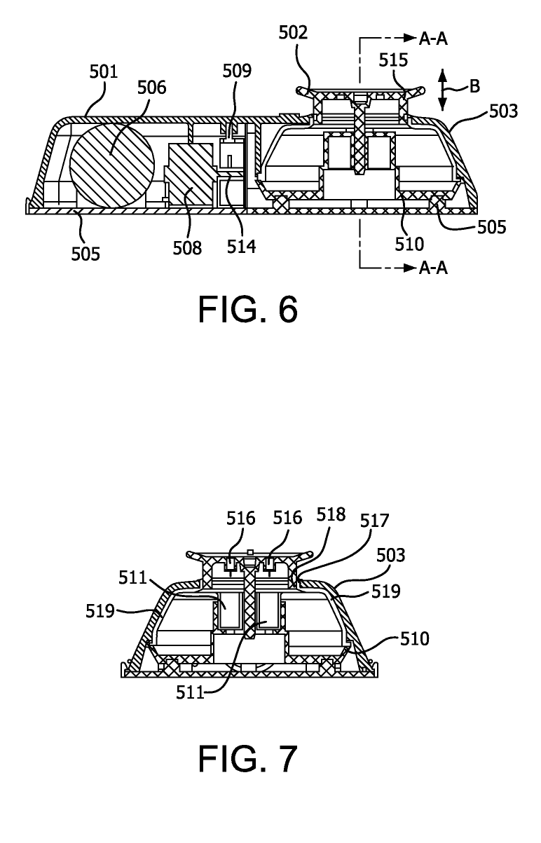

Shown in FIG. 5A is bed bug capturing device 500. The device comprises cover housing 501 and rotatable top/actuator 502. Cover housing 501 comprises upwardly sloped surface 503, and an edge having upwardly sloped segment 517 and downwardly sloped segment 518 (shown in FIGS. 6 and 7) which edge defines circular opening 504. Preferably, at least a portion of cover housing 501 is composed of a glass filled polymer having an average surface roughness of at least about 2.5 micrometers. The glass filler material may be in any suitable form, such as, for example, particles, fibers, etc. The inner portion of downwardly sloped segment 517 has a smooth, polished surface having an average surface roughness of less than about 2.3 micrometers.

Shown in FIG. 5B is base plate 505 which can be more than one piece. Base plate 505 can be made from polycarbonate. Also shown in FIG. 5B is power supply 506 (e.g., battery), battery clips 507, fan motor 508, air dam 509, dead fall trap element 510, and attractant receiving element(s) 511, which can include more than one element for housing an appropriate attractant (e.g., a vial containing an attractant composition). For completeness, shown in FIG. 5A are venting holes 512. Shown in FIGS. 5A and 5B are cooperating snap-on portions 513a and 513b.

The rotatable top/actuator 502 can be any suitable polymer material. Preferably the rotatable top/actuator 502 comprises a polymer that is sufficiently clear to allow visual inspection of the deadfall trap element 510. Preferably, the rotatable top/actuator 502 comprises polyethylene terepthalate and more preferably clear polyethylene terepthalate. The base plate(s) 505 can be snap-on pieces and can be any suitable material, such as polycarbonate. The base plate(s) 505 preferably form a tight seal with cover housing 501. The seal between base plate(s) 505 and cover housing 501 should be tight enough to prevent bed bugs from crawling between cover housing 501 and base plate(s) 505. Moreover, it is desirable for the seal to prevent attractant from escaping between the cover housing 501 and base plate(s) 505. The dead fall trap element 510 is shown as a flat surface dish having an upwardly extending wall or edge portion that extends around the perimeter of the flat surface. Attractant receiving element(s) 511 can be formed to accept one or more attractant containers, such as the polymer vials with metal foil tops discussed above.

Further details of bed bug capturing device 500 are shown in FIGS. 6 through 8.

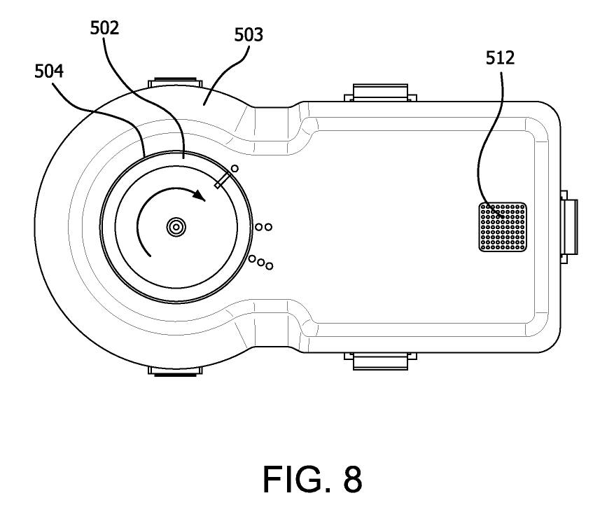

FIG. 6 is a longitudinal cross-section of the device 500. FIG. 7 is a cross-section of the device taken along line A-A in FIG. 6. FIG. 8 is a top view of the device.

As can be seen the device includes the following features not discussed immediately above. The rotatable top/actuator 502 includes support members 515, as well as piercing members 516. The rotatable top/actuator 502 can be rotated as shown in FIG. 8. Rotatable top 502 can have a diameter larger than that of cover housing opening 504. Moreover, cover housing opening 504 may be provided with a plurality of notches that can serve as stop points for support members 515 as the rotatable top/actuator 502 is rotated. Shown in FIG. 8 are three such stop points. The first point can serve as a starting point, where prior to use of the device the rotatable top/actuator 502 is in the downward position (line B in FIG. 6). To activate the device, the rotatable top/actuator 502 can be pulled up, away from the device and rotated to the second point, which can serve as the piercing position. This position is designed such that the attractant receiving elements 511 are positioned underneath piercing elements 516. At this point, the rotatable top/actuator 502 can be depressed so that piercing elements 516 can puncture the metal foil tops of the polymer vials containing the attractant compositions. After piercing the metal foils, the rotatable top/actuator 502 can be placed back in the up position and rotated to the third point. The third point can serve as a locking position for use when the device is in operation. When in this position, the attractant compositions can diffuse into the surrounding atmosphere. Motor 508 and propeller 514 provide gentle air flow (left to right in FIG. 6) over the pierced metal foils to direct the lure compositions toward cover housing opening 504 and rotatable cover/actuator 502. Bed bugs are attracted to the attractant, climb the upwardly sloped surface 503 of cover housing 501 and are drawn toward opening 504. Upon reaching the upwardly sloping portion 517 near the opening 504, the bed bug then continues to the downwardly sloping portion 518 near the opening 504 and falls into the deadfall trap element 510.

As a further feature, shown in FIGS. 6 and 7, is cover housing liner 519, which can be made from a material that bed bugs cannot climb, for example, polyethylene. Cover housing liner 519, which has an average surface roughness of less than about 2.3 micrometers can be formed to form a tight seal with the raised edges of deadfall trap element 510. This will provide a further means for stopping bed bugs from escaping from the trap once caught. The cover housing liner 519 can also be formed to fit against the inner surface of the cover housing 501. Moreover, the cover housing liner 519 can extend up to the cover housing opening 504 to provide a non-climbable surface up to the cover housing opening 504.

### EXAMPLES

### Example 1

Attempts were made to lure bed bugs of the species Cimex lectularius into a deadfall trap, The Dome™ Trap marketed by Trece Incorporated and employed in the industry to capture grain pests such as grain beetles, cigarette beetles and flour beetles. Although this trap is manufactured from molded hard plastic having an irregular outer surface, it was found that it was of insufficient roughness to act as a trap for bed bugs. When the external surface of this trap was roughened employing 120-320 grit sandpaper, it was found that bed bugs no longer avoided climbing the surface as being too slippery.

### Example 2

A 25 mm diameter smear of Tanglefoot (a sticky surface employed for trapping insects such as flies) was impregnated with 4 micrograms each of Hexenal and Octenal. Twenty-five unfed adult bed bugs of the species Cimex lectularius were placed directly on the trap. It was observed that none of the bed bugs were trapped by the sticky surface even though they were attracted to and standing upon its surface.

### Example 3

A planar coupon measuring 1.5 inch by 2.0 inches was prepared by molding polypropylene containing 20 percent by weight of glass fiber (“PP-G”). The average surface roughness of such coupon was measured using a Mahr Pocket Surf® portable roughness gage. The coupon was placed onto an inclined holder at about a 70 degree angle. An adult bed bug (Cimex lectularius) was placed onto the center of the coupon and visually monitored for about 5 minutes to determine if the bed bug was able to walk/climb the surface or was unable to hold onto the surface and fell off.

Additional coupons composed of polyethylene (“PE”); polyethylene that had been sanded with 100 grit sandpaper (“sanded PE”); and high density polyethylene (35 melt) (“HDPE”) were also evaluated. The results of such evaluation are summarized below:

| Surface | Average Roughness (μm) | Climbable by Bed Bugs |
|---|---|---|
| G-PP | 2.468 | Yes |
| Sanded PP | 3.100 | Yes |
| PE | 2.294 | No |
| HDPE | 0.214 | No |

What is claimed is:

1. A bed bug capturing device comprising:
a) a bed bug attractant element; and
b) a deadfall capturing element comprising at least one pathway comprising:
i) an upwardly sloped segment;
ii) a downwardly sloped segment having an outer portion; and
iii) a deadfall trap area:
characterized in that the upwardly sloped segment and at least the outer portion of the downwardly sloped segment possesses an average surface roughness of at least about 2.5 micrometers.

2. The device of claim 1 wherein the upwardly sloped segment and at least the outer portion of such inwardly sloped segment possesses an average surface roughness of at least about 3.0 micrometers.

3. The device of claim 1 wherein the inwardly sloped segment comprises a horizontal outer portion and a downwardly sloped inner portion.

4. The device of claim 1 wherein the inner portion of the upwardly sloped segment and the downwardly sloped segment form a continuous curve.

5. The device of claim 1 wherein the attractant element comprises at least one member of the group consisting of aldehydes and organic acids.

6. The device of claim 5 wherein the attractant element comprises at least one member of the group consisting of Hexenal, Octenal and butyric acid.

7. The device of claim 5 wherein the attractant element comprises a means for producing an air flow of between about 5 ml/cm²/min. and about 50 ml/cm²/min.

8. The device of claim 7 wherein the means of producing an air flow is a fan.

9. The device of claim 1 wherein the attractant element comprises a means for producing an air flow of between about 5 ml/cm²/min. and about 50 5 ml/cm²/min.

10. The device of claim 9 wherein the means of producing an air flow is a fan.

11. The device of claim 1 wherein at least a portion of the upwardly sloped segment and/or of the inner portion the downwardly sloped segment is composed of a glass filled polymer.

12. The device of claim 11 wherein the glass filled polymer comprises from about 10% by weight to about 30% by weight of glass filler.

13. The device of claim 12 wherein the glass filler comprises glass particles.

14. The device of claim 11, which further comprises at least one attractant receiving element.

15. The device of claim 14, which further comprises at least one polymer vial sized to fit within an opening in the at least one attractant receiving element.

16. The device of claim 15, wherein the at least one polymer vial further comprises a metal foil top.

17. The bed bug device of claim 16, which further comprises a rotatable top/actuator having at least one piercing member positioned such that when such rotatable top/actuator is rotated, such at least one piercing member will puncture the metal foil top of the polymer vial.
